(19) United States
(12) Patent Application Publication
(10) Pub. No.: US 2024/0297414 A1
(43) Pub. Date: Sep. 5, 2024

(54) CELL STACKING ASSEMBLY AND BATTERY MODULE INCLUDING THE SAME

(71) Applicant: SK On Co., Ltd., Seoul (KR)

(72) Inventors: Deok Ho NAM, Daejeon (KR); Ye Eun KIM, Daejeon (KR); Yun Joo NOH, Daejeon (KR); Jun Seo YOON, Daejeon (KR)

(21) Appl. No.: 18/590,949

(22) Filed: Feb. 29, 2024

(30) Foreign Application Priority Data
Mar. 2, 2023 (KR) 10-2023-0027856

(51) Int. Cl. H01M 50/507; H01M 10/48; H01M 50/211

(52) U.S. Cl. CPC H01M 50/507; H01M 10/482; H01M 50/211

(57) ABSTRACT

The present disclosure relates to a cell stacking assembly and a battery module including the same, the cell stacking assembly including: a plurality of battery cells stacked along a preset stacking direction and each including a first lead tab portion and a second lead tab portion; a first busbar electrically connected each of the first lead tab portions; a first busbar frame coupled with the first busbar to support the first busbar; a second busbar electrically connected each of the second lead tab portions; a second busbar frame coupled with the second busbar to support the second busbar; a first protrusion protruding from the first busbar frame and inserted into a first insertion hole positioned on the first busbar; and a second protrusion protruding from the second busbar frame and inserted into a second insertion hole positioned on the second busbar.

### CROSS-REFERENCE TO RELATED PATENT APPLICATION

The present application claims priority under 35 U.S.C. § 119 (a) to Korean patent application number 10-2023-0027856 filed on Mar. 2, 2023, in the Korean Intellectual Property Office, the entire disclosure of which is incorporated by reference herein.

### BACKGROUND OF THE INVENTION

### 1. Field

The present disclosure relates to a busbar assembly provided in a cell stacking assembly or battery module.

### 2. Description of the Related Art

A typical cell stacking assembly or a battery module including the same includes a first busbar and a second busbar for electrically connecting a plurality of battery cells. A first busbar and a second busbar have different shapes and so they must be assembled at the designed positions. However, due to the characteristics of the first a busbar and a second busbar that they are not compatible with each other, there is a possibility that incorrect assembly may occur by an operator when a first busbar and a second busbar are assembled with a plurality of battery cells. Resolving such incorrect assembly may take a lot of time. In addition, there is a problem in that surface treatment performed on a first busbar and a second busbar before the first busbar and the second busbar are assembled is damaged due to incorrect assembly.

### SUMMARY OF THE INVENTION

First, a technical problem that is intended to be solved by the present disclosure is to prevent confusion between busbars provided on both sides of stacked battery cells.

Second, another technical problem that is intended to be solved by the present disclosure is to compactly utilizing a space of a module case in which a cell stacking assembly is accommodated.

Third, still another technical problem that is intended to be solved by the present disclosure is to allow an operator to easily confirm whether incorrect assembly has occurred when assembling a busbar.

Fourth, yet another technical problem that is intended to be solved by the present disclosure is to reduce the cost of a busbar and reduce the time required to confirm whether assembly of a busbar is normal.

Meanwhile, a cell stacking assembly or a battery module including the same according to the present disclosure can be widely applied in the field of electric vehicles, battery charging stations, energy storage system (ESS), and green technology such as photovoltaics and wind power generation using batteries. In addition, a cell stacking assembly or a battery module including the same according to the present disclosure can be used in eco-friendly mobility, including electric vehicles and hybrid vehicles, to prevent climate change by suppressing air pollution and greenhouse gas emissions.

To solve the technical problems described above, a cell stacking assembly according to the present disclosure may include: a plurality of battery cells stacked along a preset stacking direction and each including a first lead tab portion and a second lead tab portion; a first busbar positioned in a direction in which the first lead tab portion protrudes to electrically connect each of the first lead tab portions; a first busbar frame coupled with the first busbar to support the first busbar; a second busbar positioned in a direction in which the second lead tab portion protrudes to electrically connect each of the second lead tab portions; a second busbar frame coupled with the second busbar to support the second busbar; a first protrusion protruding from the first busbar frame toward the first busbar; a first insertion hole positioned on the first busbar and into which the first protrusion is inserted; a second protrusion protruding from the second busbar frame toward the second busbar; and a second insertion hole positioned on the second busbar and into which the second protrusion is inserted.

The first busbar, the first busbar frame, the second busbar, and the second busbar frame may extend along the stacking direction, which is a direction in which the plurality of battery cells are stacked.

The distance from the front surface of the first busbar frame to the first protrusion along the stacking direction may be different from the distance from the front surface of the second busbar frame to the second protrusion along the stacking direction.

The height to the first protrusion may be different from the height to the second protrusion.

Meanwhile, the cell stacking assembly may further include: a first protruding portion protruding from the first busbar frame in a direction toward the first busbar to be coupled with the first busbar; a first through-hole formed through the first busbar at a position of the first busbar at which the first protruding portion is coupled; a second protruding portion protruding from the second busbar frame in a direction toward the first busbar to be coupled with the second busbar; and a second through-hole formed through the second busbar at a position of the second busbar at which the second protruding portion is coupled.

The protruding height of the first protruding portion based on the first busbar frame may be greater than the protruding height of the first protrusion; and the protruding height of the second protruding portion based on the second busbar frame may be greater than the protruding height of the second protrusion.

In addition, the first protruding portion may be thermally bonded to couple the first busbar with the first busbar frame; and the second protruding portion may be thermally bonded to couple the second busbar with the second busbar frame.

Meanwhile, the inner diameter of the first insertion hole may be identical to the inner diameter of the first through-hole; and the inner diameter of the second insertion hole may be identical to the inner diameter of the second through-hole.

In addition, the maximum outer diameter of the first protruding portion may be larger than the maximum outer diameter of the first protrusion; and the maximum outer diameter of the second protruding portion may be larger than the maximum outer diameter of the second protrusion.

Meanwhile, the first protrusion may be provided in a plural number on the first busbar frame along a stacking direction in which the plurality of battery cells are stacked; the first insertion hole may include a plurality of first insertion holes that are formed through the first busbar at a position corresponding to any one of the first protrusions; the second protrusion may be provided in a plural number on the second busbar frame along a stacking direction in which the plurality of battery cells are stacked; and the second insertion hole may include a plurality of second insertion holes that are formed through the second busbar at a position corresponding to any one of the second protrusions.

The plurality of first protrusions may be disposed at a preset first interval; and the plurality of second protrusions may be disposed at a preset second interval.

The first busbar may include a plurality of first busbar plates, and each of the plurality of first busbar plates may include any one insertion hole among the plurality of first insertion holes; and the second busbar may include a plurality of second busbar plates, and each of the plurality of second busbar plates may include any one insertion hole among the plurality of second insertion holes.

In addition, the distance from the front surface of the first busbar frame to each of the plurality of first insertion holes may be different from the distance from the front surface of the second busbar frame to each of the plurality of second insertion holes.

Meanwhile, the first busbar may include a first terminal that is provided to detect the voltage of the plurality of battery cells; and the second busbar may include a second terminal that is electrically connected to the first busbar.

The distance from the front surface of the first busbar frame to the first terminal along the stacking direction, which is a direction in which the plurality of battery cells are stacked, may be different from the distance from the front surface of the second busbar frame to the second terminal along the stacking direction.

Meanwhile, the present disclosure provides a battery module including: the cell stacking assembly; and a module case accommodating the cell stacking assembly therein.

First, the present disclosure may prevent confusion between busbars provided on both sides of stacked battery cells, thereby increasing efficiency of an assembling process.

Second, the present disclosure may allow for compactly utilizing a space of a module case in which a cell stacking assembly is accommodated.

Third, the present disclosure may allow an operator to easily confirm whether incorrect assembly has occurred when assembling a busbar.

Fourth, the present disclosure may reduce the cost of a busbar and reduce the time required to confirm assembly of busbars.

### BRIEF DESCRIPTION OF THE DRAWINGS

FIG. 1 shows a part of a battery module described in the present disclosure.

FIG. 2 shows an example of a busbar assembly.

FIGS. 3A and 3B show examples in which a first terminal and a second terminal are coupled, respectively.

FIGS. 4A and 4B show examples of a first busbar plate and a second busbar plate, respectively.

FIG. 5A shows an example of a first busbar frame coupled with a first busbar. FIG. 5B shows an example of a second busbar frame coupled with a second busbar.

FIG. 6A shows a part of a first busbar frame. FIG. 6B shows a part of a second busbar frame.

FIG. 7 shows an example of a second busbar frame, a second busbar plate, and a second terminal that are coupled.

FIG. 8A shows an example of the second protrusion and the second insertion hole. FIG. 8B shows a cross-section of the second protrusion and the second insertion hole.

### DETAILED DESCRIPTION

Hereinafter, preferred embodiments of the present disclosure will be described in detail with reference to the attached drawings. The configuration or control method of the apparatus described below is only for explaining the embodiments of the present disclosure and is not intended to limit the scope of the present disclosure, and the same reference numerals used throughout the specification indicate the same components.

Specific terms used in the present specification are merely for convenience of explanation and are not used to limit the illustrated embodiments.

For example, expressions such as “same” and “is the same” not only indicate a strictly identical state, but also indicate a state in which there is a difference in tolerance or the degree to which the same function is obtained.

For example, expressions representing relative or absolute arrangement such as “in a certain direction,” “along a certain direction,” “side by side,” “perpendicularly,” “at the center,” “concentric,” or “coaxial,” not only strictly represent the arrangement, but also represent the state of relative displacement with a tolerance, or an angle or distance at which the same function is obtained.

To explain the present disclosure, it will be described below based on a spatial orthogonal coordinate system with X, Y, and Z axes orthogonal to each other. Unless otherwise mentioned, the Z-direction refers to a height direction, and the X-direction (or a first direction) refers to any one direction among directions that are perpendicular to the height direction. In addition, the Y-direction (or a second direction) refers to a direction that is perpendicular to the Z-direction and the X-direction.

However, the X-direction, Y-direction, and Z-direction mentioned hereinafter are for explanation so that the present disclosure may be clearly understood, and of course, the directions may be defined differently depending on where the reference is placed.

The use of terms such as ‘first, second, and third’ in front of the components mentioned below is only to avoid confusion about the components to which they are referred and is irrelevant to the order, importance, or master-slave relationship between the components, etc. For example, an invention that includes only a second component without a first component may also be implemented.

As used in the present specification, singular expressions include plural expressions unless the context clearly dictates otherwise.

A battery cell or a cell described in the present specification refers to the basic unit of a lithium secondary battery, specifically a lithium ion battery, which may be used by charging and discharging electrical energy. The main components of the battery cell are a cathode, an anode, a separator, and an electrolyte, and these main components are placed in a case (or pouch). The battery cell may further include a tab that is each connected to the cathode and the anode for electric connection to the outside and that protrudes to the outside of the pouch.

Meanwhile, a battery module described in the present specification refers to a battery assembly in which one or more of the battery cells are grouped and placed in a case to protect them from external shock, heat, vibration, or the like. The battery assembly may be connected to a busbar assembly accommodated inside through an external connection line and to supply electricity to the outside or receive electricity from the outside and store it in the battery cell.

In addition, a battery pack refers to a set in which a preset number of the battery modules are gathered together to achieve a finally desired voltage or power.

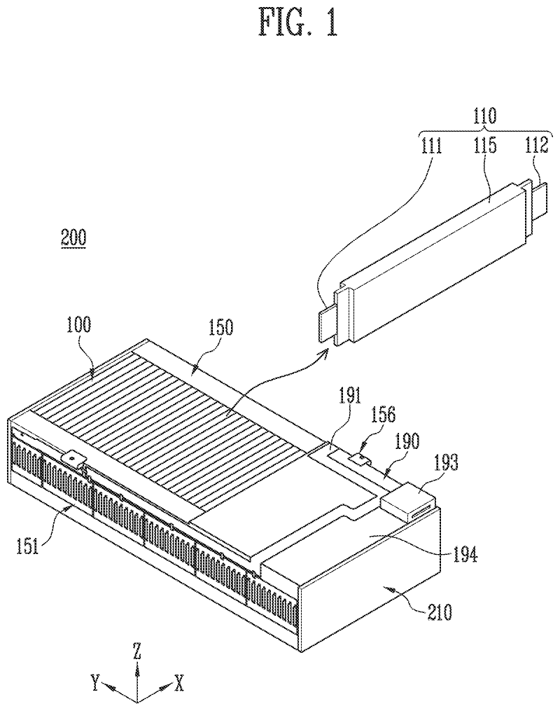

FIG. 1 shows a part of a battery module 200 described in the present disclosure. A battery module 200 may further include a cell stacking assembly 100 and a module case 210 accommodating the cell stacking assembly 100. However, FIG. 1 illustrates only a part of the module case 210 to show the cell stacking assembly 100.

The module case 210 may include a module body (not shown) of which an upper surface (not shown) is open to form an accommodating space (not shown) in which the cell stacking assembly 100 is accommodated through the opened upper surface; and a module cover (not shown) that is coupled to the module body to open and close the opened upper surface.

The cell stacking assembly 100 may include a plurality of battery cells 110; and a busbar assembly 150 that extends along a stacking direction (Y-direction), which is a direction in which the plurality of battery cells are stacked, and that is each connected to the plurality of battery cells 110.

When an enlarged view of one of the individual battery cells 110 in FIG. 1 is viewed, the battery cell 110 includes: a main body 115 receiving electrical energy from the outside and storing it or supplying it to the outside; and a first lead tab portion 111 and a second lead tab portion 112 that protrude in opposite directions.

The main body 115 may include a cathode plate, an anode plate, a separator, and an electrolyte solution. Specifically, the main body 115 may include an electrode assembly (not shown). The electrode assembly alternately disposes separators between a cathode plate and an anode plate, and may be formed by positioning the separators between a cathode plate and an anode plate and winding them in a spiral shape.

In addition, the electrode assembly may be formed in a stacking arrangement by stacking a separator between a cathode plate and an anode plate.

The first lead tab portion 111 and the second lead tab portion 112 may be connected to the plurality of cathode plates and anode plates, respectively, and may protrude for electrical connection to the outside. The first lead tab portion 111 and the second lead tab portion 112 are terminals for connection to other battery cells 110 or external devices, for example, terminals electrically connected to a busbar assembly 150, and they may be provided as a cathode lead tab and an anode lead tab, respectively. If the first lead tab portion 111 and the second lead tab portion 112 are a cathode lead tab and an anode lead tab, respectively, the first lead tab portion 111 and the second lead tab portion 112 will be electrically connected to a cathode plate and an anode plate, respectively.

The first lead tab portion 111 and the second lead tab portion 112 may protrude in opposite directions along a stacking direction in which the plurality of battery cells are stacked and a direction (X-direction) that is perpendicular to the height direction (Z-direction) of the module case 210, respectively.

The first lead tab portion 111 and the second lead tab portion 112 may be formed of a material with excellent electrical conductivity. In addition, as shown in FIG. 1, the battery cell 110 may include one first lead tab portion 111 and one second lead tab portion 112.

The cell stacking assembly 100 is positioned outside the first lead tab portion 111 and the second lead tab portion 112 and include a busbar assembly 150 that is electrically connected to the first lead tab portion 111 and the second lead tab portion 112.

The busbar assembly 150 includes: a first busbar 151 electrically connected to each first lead tab portion 111 of the plurality of battery cells 110; a first busbar frame 152 supporting the first busbar 151; a second busbar 156 electrically connected to each second lead tab portion 112 of the plurality of battery cells 110; and a second busbar frame supporting the second busbar 156.

In terms of electrical polarity, each first lead tab portion 111 of the plurality of battery cells 110 may be a lead tab having either a positive or negative polarity. Likewise, each second lead tab portion 112 of the plurality of battery cells 110 may also be a lead tab having either a positive or negative polarity. This is because the arrangement of each lead tab may vary depending on the voltage and current desired to be obtained through the battery module 200. Therefore, based on electrical polarity, the first busbar 151 and the second busbar 156 may electrically connect a plurality of cathode lead tabs and a plurality of cathode lead tabs by serial connection, parallel connection or a combination of serial and parallel connections.

Meanwhile, the busbar assembly 150 may further include a sensing portion 190 which is capable of measuring the voltage applied to the plurality of battery cells 110 or the temperature of the battery cells 110 and transmitting the magnitude of the voltage of the plurality of battery cells 110 to the outside. The sensing portion 190 may further sense and transmit the temperature of the battery cells.

An example of the sensing portion 190 is a sensing terminal connected to a busbar. In addition, another example of the sensing portion 190 is a cell management unit (CMU).

The battery cell 110 may be a pouch-type secondary battery.

The sensing portion 190 may further include: a circuit portion 191 interconnecting the first busbar 151 and the second busbar 156; and an external connection device 193 connected to the circuit portion 191 to transmit voltage or temperature data to the outside.

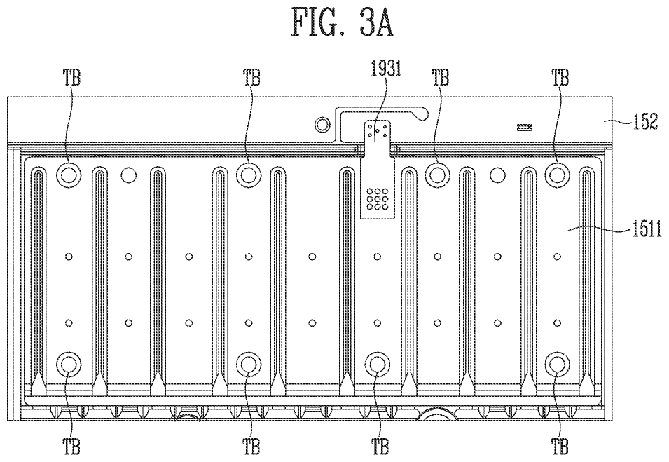

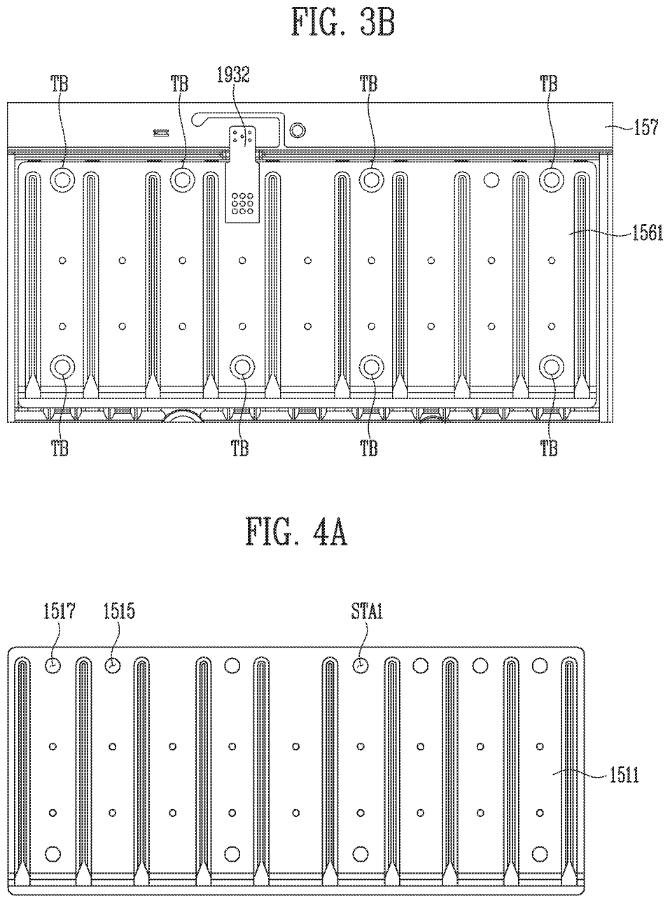

In addition, the sensing portion 190 may further include a first terminal 1931 (see FIG. 3A) connecting the circuit unit 191 and the first busbar 151; and a second terminal 1932 (see FIG. 3A) connecting the circuit unit 191 and the second busbar 156.

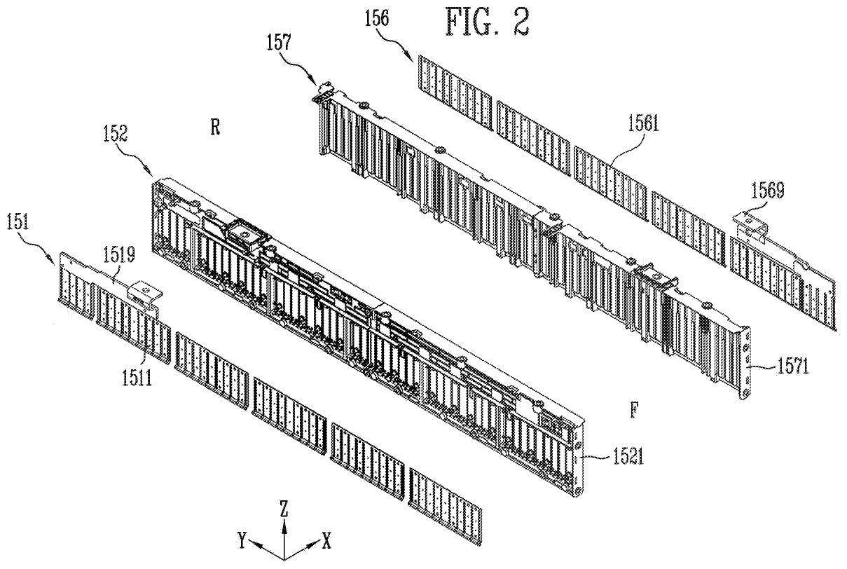

Only one of each of the first terminal 1931 and the second terminal 1932 may be provided on the first busbar 151 and the second busbar 156, or they may be provided on each of a first busbar plate 1511 (see FIG. 2) and a second busbar plate 1561 (see FIG. 2), which will be described later.

In addition, the battery module 200 or the cell stacking assembly 100 may include a plate-shaped supporting portion 194 for supporting the sensing portion 190.

The circuit portion 191 may be provided in the form of a flexible printed circuit board (FPCB). By coupling the circuit portion 191 to the support portion 194, the stress applied to the circuit portion 191 may be distributed.

In addition, the first busbar 151 and the second busbar 156 may be connected to the circuit portion 191. The first busbar 151 and the second busbar 156 are high-voltage busbars capable of transmitting a current generated from each of the plurality of battery cells 110 to the outside.

FIG. 2 shows an example of a busbar assembly 150. A busbar assembly 150 may be provided for electric connection between a plurality of battery cells and the outside. The busbar assembly 150 may include a first busbar 151 that extends along the stacking direction of the plurality of battery cells 110 and that is positioned on a side surface where the first lead tab portion 111 provided in each of the plurality of battery cells 110 is positioned to be electrically connected to each of the first lead tab portion 111; and a first busbar frame 152 supporting the first busbar 151 and forming one side surface of the plurality of battery cells 100. In addition, the busbar assembly 150 may include a second busbar 156 that extends along the stacking direction of the plurality of battery cells 110 and that is positioned on a side surface where the second lead tab portion 112 provided in each of the plurality of battery cells 110 is positioned to be electrically connected to each of the first lead tab portion 111; and a second busbar frame 157 supporting the second busbar 156 and forming one side surface of the plurality of battery cells 100.

Meanwhile, in the present disclosure, for convenience, the side where the external connection device 193 is positioned is set as the front (F), and the opposite side is set as the rear (R).

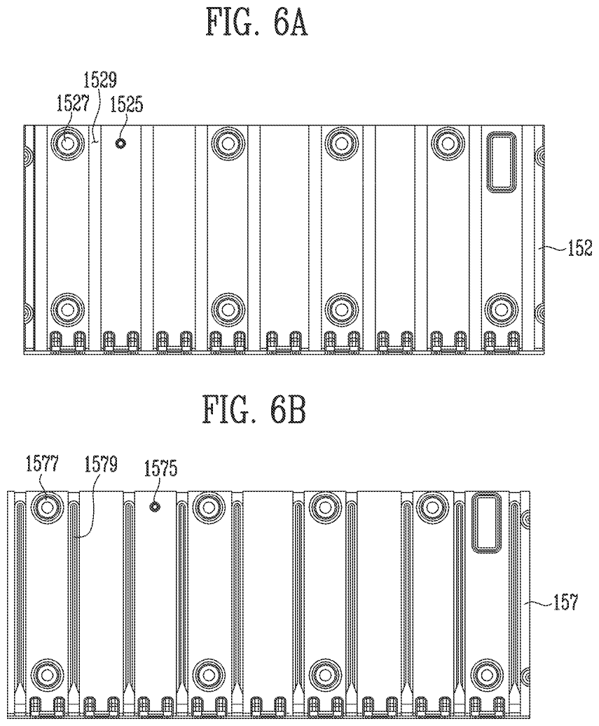

The first busbar frame 152 may include a first extension hole 1529 (see FIG. 6A) formed by extending along the height direction of the battery module 200 or the height direction of the module case 210 to insert the first lead tab portion 111. The first lead tab portion 111 is inserted through the first extension hole 1529, and then will be electrically connected to the first busbar 151.

The first busbar frame 152 may be formed of an insulating material. This is for electrical insulation between the main body 115 and the first busbar 151.

The first busbar 151 may include a first busbar plate 1511 that is electrically connected to the first lead tab portion 111 and provided in parallel with the first busbar frame 152.

The first busbar plate 1511 may be provided in a plural number so that the first busbar 151 is formed by electrically connecting the plurality of first busbar plates 1511.

The first busbar 151 may further include the first busbar plate 1511; and a first external connection portion 1519 for electrically connecting the first busbar plate 1511 to the outside.

The second busbar frame 157 may include a second extension hole 1579 (see FIG. 6B) formed by extending along the height direction of the battery module 200 or the height direction of the module case 210 to insert the second lead tab portion 112. The second lead tab portion 112 is inserted through the second extension hole 1579, and then will be electrically connected to the second busbar 156.

The second busbar frame 157 may be formed of an insulating material. This is for electrical insulation between the main body 115 and the second busbar 156.

The first busbar frame 152 may include a front surface 1521 of the first busbar frame that forms a front surface when the first busbar frame 152 is viewed from the front. Likewise, the second busbar frame 157 may include a front surface 1571 of the second busbar frame that forms a front surface when the second busbar frame 157 is viewed from the front.

The second busbar 156 may include a second busbar plate 1561 that is electrically connected to the second lead tab portion 112 and provided in parallel with the second busbar frame 157.

The second busbar plate 1561 may be provided in a plural number so that the second busbar 156 is formed by electrically connecting the plurality of second busbar plates 1561.

The second busbar 156 may further include the second busbar plate 1561; and a second external connection portion 1569 for electrically connecting the second busbar plate 1561 to the outside.

The first busbar plate 1511 may be provided in a plate shape and may be coupled to the first busbar 151. Likewise, the second busbar plate 1561 may be provided in a plate shape and may be coupled to the second busbar 156.

Considering that the material of the first busbar plate 1511 is a polymer material with electrical insulation and the material of the first busbar 151 is a metal material with excellent electrical conductivity, the first busbar plate 1511 and the first busbar 151 may be coupled by a method called thermal bonding. Alternatively, upon injecting the first busbar plate 1511, the first busbar 151 may be inserted in advance and coupled. However, the coupling method is not limited thereto, and the first busbar plate 1511 and the first busbar 151 may be coupled using other methods.

Likewise, considering that the material of the second busbar plate 1561 is a polymer material with electrical insulation and the material of the second busbar 156 is a metal material with excellent electrical conductivity, the second busbar plate 1561 and the second busbar 156 may be coupled by a method called thermal bonding. Alternatively, upon injecting the first busbar plate 1561, the second busbar 156 may be inserted in advance and coupled. However, the coupling method is not limited thereto, and the second busbar plate 1561 and the second busbar 156 may be coupled using other methods.

Referring to FIG. 2, the length of the first busbar 151 and the second busbar 156 may be identical to each other in the front-rear direction. Likewise, the length of first busbar frame 152 and the length of the second busbar frame 157 may be identical to each other.

FIGS. 3A and 3B show examples in which a first terminal 1931 and a second terminal 1932 are coupled, respectively. The first terminal 1931 may connect the first busbar frame 152 to the circuit portion 191.

FIG. 3A shows an example in which the first terminal 1931 connects the first busbar plate 1511 and the first circuit portion 191. Since the first busbar plate 1511 is provided in a plural number, the first terminal 1931 is provided in the same number as the first busbar plate 1511, so that each of the first busbar plates 1511 is connected to the circuit portion 191. Alternatively, the first terminal 1931 may be positioned on one first busbar plate 1511 among the plurality of first busbar plates 1511.

In addition, the first busbar plate 1511 may be coupled to the first busbar frame 152 through a thermal bonding portion (TB).

FIG. 3B shows an example in which the second terminal 1932 connects the second busbar plate 1561 and the circuit portion 191. Since the second busbar plate 1561 is provided in plural number, the second terminal 1932 is provided in the same number as the second busbar plate 1561, so that each of the second busbar plates 1561 is connected to the circuit portion 191. Alternatively, the second terminal 1932 may be positioned on one second busbar plate 1561 of the plurality of second busbar plates 1561.

In addition, the second busbar plate 1561 may be coupled to the second busbar frame 157 through a thermal bonding portion (TB).

Referring to FIGS. 2, 3A, and 3B, the first external connecting portion 1519 and the second external connecting portion 1569 may be positioned differently from each other. In addition, the positions of the first terminal 1931 and the second terminal 1932 may be different from each other. This is to maximize the use of the internal space of a module case 210 in which the cell stacking assembly 100 is accommodated.

Therefore, even when the lengths of the first busbar 151 is identical to the second busbar 156, the shapes of the first busbar 151 and the second busbar 156 may be different. However, when the first busbar 151 and the second busbar 156 are coupled with the first busbar frame 152 and the second busbar frame 157, in the case where the first busbar 151 and the second busbar 156 are mixed, it is not easy to distinguish them, and incorrect assembly may occur when assembling the cell stacking assembly 100.

A lot of confirmation time will be taken to filter out the above incorrect assembly. In addition, after incorrect assembly is discovered, it may be difficult to separate and reuse it. This is because when an incorrectly assembled first busbar 151 is separated from a second busbar frame 157 or an incorrectly assembled second busbar 156 is separated from a first busbar frame 152, the surface of a busbar may be damaged. In general, busbars are generally surface-treated to increase bonding strength or weldability, but damage to surface treatment may occur when a busbar is separated.

Therefore, to prevent incorrect assembly in advance, it is preferable that a mark or symbol that distinguishes the first busbar 151 and the second busbar 156 is marked in advance on the first busbar 151 and the second busbar 156.

For example, when an operator assembles the first busbar 151 and the second busbar frame 157, if assembly is not possible between the first busbar 151 and the second busbar frame 157, the operator may immediately recognize incorrect assembly.

To this end, referring to FIGS. 3A and 3B, the cell stacking assembly 100 includes: a first protrusion 1525 protruding in a direction toward the first busbar 151 along a direction in which the first lead tab portion 111 (see FIG. 1) protrudes from the first busbar frame 152; a first insertion hole 1515 which is positioned on the first busbar 151 and through which the first protrusion 1525 is inserted when the first busbar 151 is coupled with the first busbar frame 152; a second protrusion 1575 protruding in a direction toward the second busbar 156 along a direction in which the second lead tab portion 112 (see FIG. 1) protrudes from the second busbar frame 157; and a second insertion hole 1565 which is positioned on the second busbar 156 and through which the second protrusion 1575 is inserted when the second busbar 156 is coupled with second first busbar frame 157.

In addition, the battery module 200 will include the cell stacking assembly 100. In addition, the battery module 200 may further include a module case 210 (see FIG. 1) accommodating the cell stacking assembly 100 therein.

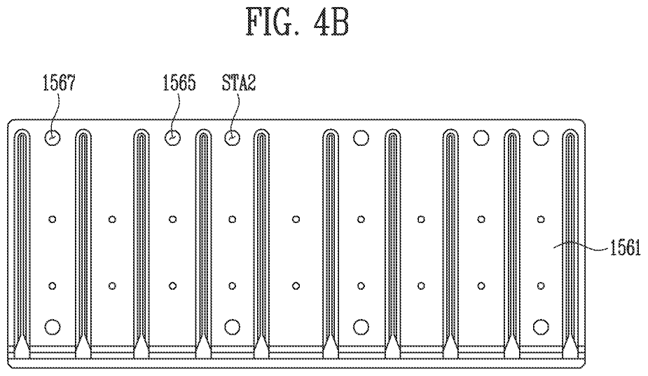

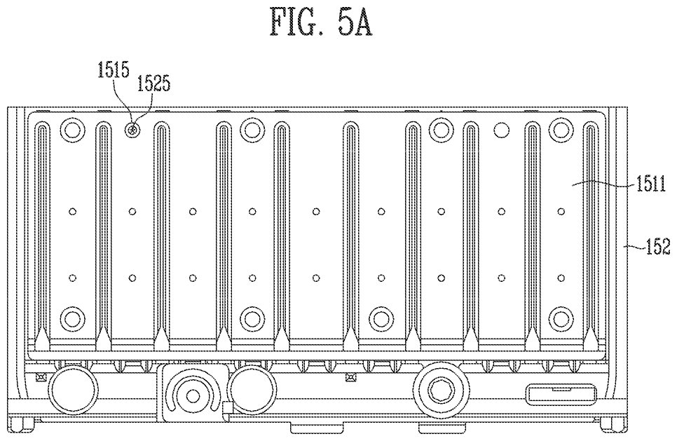

FIGS. 4A and 4B show examples of a first busbar plate 1511 and a second busbar plate 1561, respectively.

Referring to FIG. 4A, the first busbar 151 or the first busbar plate 1511, which forms a part of the first busbar 151, may include a first through-hole 1517 coupled with a first protrusion 1525 (see FIG. 6A), which will be described later; and a first insertion hole 1515 coupled with the first protrusion 1525 (see FIG. 6A), which will be described later. The first through-hole 1517 may be provided for thermal bonding with the first busbar plate 1511, and the first insertion hole 1515 may be provided to prevent the above-described incorrect assembly.

Meanwhile, the first terminal 1931 may be coupled by the first busbar frame 152 to be electrically connected to the first busbar plate 1511. To this end, the first busbar 151 or the first busbar plate 1511 may further include a first coupling hole STA1 for coupling the first terminal 1931 and the first busbar plate 1511.

The first coupling hole STA1, the first insertion hole 1515, and the first through-hole 1517 may all be formed in the same shape and size for convenience of processing. That is, the first coupling hole STA1, the first insertion hole 1515, and the first through-hole 1517 may be used interchangeably with each other according to the purpose.

For example, the first insertion hole 1515 may be used like the first through-hole 1517 so that the first protrusion 1525 may be inserted to form a thermal binding portion (TB). In addition, the first through-hole 1517 may also be used as the first coupling hole STA1.

Referring to FIG. 4A, it can be seen that the first coupling hole STA1, the first insertion hole 1515, and the first through-hole 1517 are formed at specific positions. If holes of the same size are formed on the first busbar 151 at a preset interval along the stacking direction, one for each individual bar shape of the first busbar 151, the first busbar 151 and the second busbar 156 may be compatible with each other. However, if holes are formed through punching even at unnecessary places, the structural rigidity of the first busbar 151 and the second busbar 156 may be weakened. Therefore, it would be preferable that the plurality of holes provided on the first busbar 151 and the second busbar 156 are punched only at necessary positions.

The first busbar 151 may form a plurality of first through-holes 1517 at a preset interval as first through-holes 1517 for thermal bonding, and only one first insertion hole 1515 provided on the first busbar plate 1511 may be enough to prevent incorrect assembly of the first busbar plate 1511 and the second busbar plate 1561. Of course, the first insertion holes 1515 may also be provided in a plural number.

Referring to FIG. 4B, the second busbar 156 or the second busbar plate 1561, which forms a part of the second busbar 156, may include a second through-hole 1567 coupled with a second protrusion 1575 (see FIG. 6B), which will be described later; and a second insertion hole 1565 coupled with a second protrusion 1575 (see FIG. 6B), which will be described later. The second through-hole 1567 may be provided for thermal bonding with the second busbar plate 1561, and the second insertion hole 1565 may be provided to prevent the above-described incorrect assembly.

Meanwhile, the second terminal 1932 may be coupled by the second busbar frame 157 to be electrically connected to the second busbar plate 1561. To this end, the second busbar 156 or the second busbar plate 1561 may further include a second coupling hole STA2 for coupling the second terminal 1932 and the second busbar plate 1561.

The second coupling hole STA2, the second insertion hole 1565, and the second through-hole 1567 may all be formed in the same shape and size for convenience of processing. That is, the second coupling hole STA2, the second insertion hole 1565, and the second through-hole 1567 may be used interchangeably with other according to the purpose.

For example, the second insertion hole 1565 may be used like the second through-hole 1567 so that the second protrusion 1575 may be inserted to form a thermal binding portion (TB). In addition, the second through-hole 1567 may also be used as the second coupling hole STA2.

Referring to FIG. 4B, it can be seen that the second coupling hole STA2, the second insertion hole 1565, and the second through-hole 1567 are formed at specific positions. If holes of the same size are formed on the second busbar 156 at a preset interval along the stacking direction, one for each individual bar shape of the second busbar 156, the first busbar 151 and the second busbar 156 may be compatible with each other. However, if holes are formed through punching even at unnecessary places, the structural rigidity of the first busbar 151 and the second busbar 156 may be weakened. Therefore, it will be preferable that the plurality of holes provided on the first busbar 151 and the second busbar 156 are punched only at necessary positions.

Referring to FIGS. 4A and 4B, the distance from the front surface 1521 of the first busbar frame to the first insertion hole 1515 may be different from the distance from the front surface 1571 of the second busbar frame to the second insertion hole 1565.

In addition, as an additional embodiment, along the height direction of the module case 210, the height of the first insertion hole 1515 may be positioned differently from the height of the second insertion hole 1565. However, it will preferable that the first insertion hole 1515, the first through-hole 1517, and the first coupling hole STA1 are positioned at the same height and have the same size. Likewise, it is preferable that the second insertion hole 1565, the second through-hole 1567, and the second coupling hole STA2 are positioned at the same height and have the same size.

This is to ensure compatibility between the holes. For example, referring to FIGS. 3A and 4A, when the first terminal 1931 is coupled with the first busbar frame 152 through the first coupling hole STA1, another other adjacent hole at the same height may be utilized as the first through-hole 1517 for thermal bonding. This is also the case of a second terminal 1932.

The distance from the front surface 1521 of the first busbar frame to the first insertion hole 1515 may be different from the distance from the front surface 1571 of the second busbar frame to the second insertion hole 1565.

The second busbar 156 may form a plurality of second through-holes 1567 at a preset interval as second through-holes 1517 for thermal bonding, and only one second insertion hole 1565 provided on the second busbar plate 1561 may be enough to prevent incorrect assembly of the first busbar plate 1511 and the second busbar plate 1561. Of course, the second insertion holes 1565 may also be provided in a plural number.

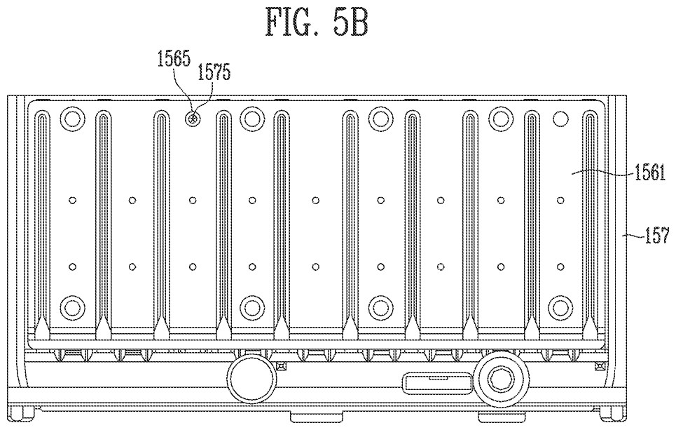

FIG. 5A shows an example of a first busbar frame 152 coupled with a first busbar 151. FIG. 5B shows an example of a second busbar frame 157 coupled with a second busbar 156.

The cell stacking assembly 100 may further include: a first protrusion 1525 protruding from the first busbar frame 152 in a direction toward the first busbar 151 to be coupled with the first busbar 151; and a first through-hole 1517 formed through the first busbar 151 at a position where the first busbar 151 is coupled with the first protrusion 1525.

In addition, the cell stacking assembly 100 may further include a second protrusion 1575 protruding from the second busbar frame 157 in a direction toward the second busbar 155 to be coupled with the second busbar 155; and a second through hole 1567 formed through the second busbar 156 at a position where the second busbar 156 is coupled with the second protrusion 1575.

The first busbar frame 152 may include a first protrusion 1525 protruding from the first busbar frame 152 toward the first busbar 151. Likewise, the second busbar frame 157 may include a second protrusion 1575 protruding from the second busbar frame 157 toward the second busbar 156.

Along the direction in which the plurality of battery cells 110 are stacked, the distance from the front surface 1521 of the first busbar frame to the first protrusion 1525 may be different from the distance from the front surface 1571 of the second busbar frame to the second protrusion 1575. This is to prevent incorrect assembly of the first busbar frame 152 with the second busbar 156 or the second busbar plate 1561 or incorrect assembly of the second busbar frame 157 with the second busbar 156 or the first busbar plate 1511.

Therefore, the first busbar 151 or the first busbar plate 1511 may include a first insertion hole 1515 into which the first protrusion 1525 is inserted.

Likewise, the second busbar 156 or the second busbar plate 1561 may include a second insertion hole 1565 into which the second protrusion 1575 is inserted.

Along the direction in which the plurality of battery cells 110 are stacked, the distance from the front surface 1521 of the first busbar frame to the first insertion hole 1515 may be different from the distance from the front surface 1571 of the second busbar frame to the second insertion hole 1565.

When the first protrusion 1525 and the second protrusion 1575 are positioned at the first insertion hole 1515 and the second insertion hole 1565, respectively, an operator will be able to immediately confirm from the outside.

For example, when the first busbar 151 and the second busbar frame 157 are coupled, since the positions of the first insertion hole 1515 and the second protrusion 1575 are different, the first busbar 151 and a part of the second busbar frame 157 may be spaced apart upon assembly. In addition, an operator will be able to immediately recognize that there is no first protrusion 1525 that should be exposed through the first insertion hole 1515.

The diameters of the first protrusion 1525 and the second protrusion 1575 may be smaller than the inner diameter of the first insertion hole 1515 and the inner diameter of the second insertion hole 1565, respectively. This is because an operator worker only needs to confirm the assembly and so there is no need to apply an excessive force to couple the same.

FIG. 6A shows a part of a first busbar frame 152. FIG. 6B shows a part of a second busbar frame 157. Specifically, FIG. 6A shows a part of coupling of one first busbar plate 1511 among a plurality of first busbar plates 1511 in the first busbar frame 152. FIG. 6B shows a part of coupling of one second busbar plate 1561 among a plurality of second busbar plates 1561 in the second busbar frame 157.

The first protruding portion 1527 may be coupled with the first through-hole 1517 by thermal bonding to form a thermal bonding portion TB (see FIG. 3A). The second protruding portion 1577 may be coupled with the second through-hole 1567 by thermal bonding to form a thermal bonding portion TB (see FIG. 3B).

Referring to FIG. 3A, after thermal bonding, the outer diameter of the first protruding portion 1527 exposed to the outside of the first busbar 151 may be larger than the inner diameter of the first through-hole 1517. Likewise, referring to FIG. 3B, after thermal bonding, the outer diameter of the second protruding portion 1577 exposed to the outside of the second busbar 156 may be larger than the inner diameter of the second through-hole 1567.

The maximum outer diameter of the first protruding portion 1527 may be larger than the maximum outer diameter of the first protrusion 1525. In addition, the maximum outer diameter of the second protruding portion 1577 may be larger than the maximum outer diameter of the second protrusion 1575.

In addition, the protruding height of the first protruding portion 1527 based on the first busbar frame 152 may be greater than the protruding height of the first protrusion 1525, and the protruding height of the second protruding portion 1577 based on the second busbar frame 157 may be greater than the protruding height of the second protrusion 1575. This is because at least a part of the first protruding portion 1527 needs to protrude to the outside of the first busbar plate 1511 so that the first protruding portion 1527 couples the first busbar frame 152 and the first busbar plate 1511 through thermal bonding. On the other hand, the first protrusion 1525 does not need to protrude outward to confirm incorrect assembly. The same reason will apply to the second protrusion 1575 and the second protruding portion 1577.

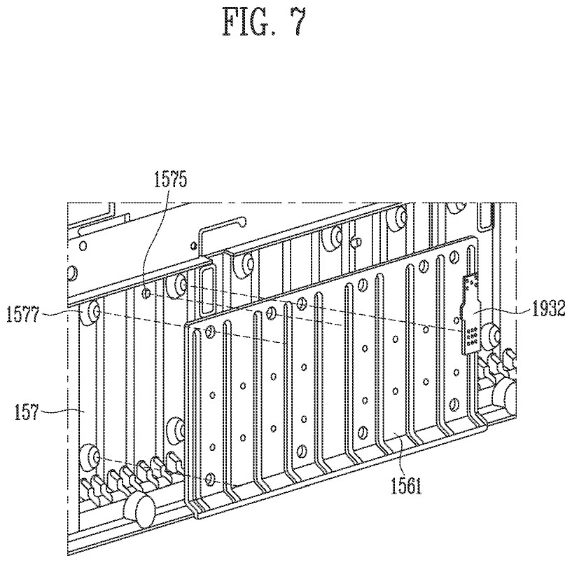

FIG. 7 shows an example of a second busbar frame 157, a second busbar plate 1561, and a second terminal 1932 that are coupled. Referring to FIG. 7, the second busbar frame 157 and the second busbar plate 1561 may be coupled through the second protruding portion 1577 and a second through-hole 1567 provided at a position corresponding to the second protruding portion. An operator may recognize that the second busbar frame 157 and the second busbar plate 1561 are assembled by confirming that the second protrusion 1575 is exposed through the second insertion hole 1565.

The second terminal 1932 may be electrically connected to the second busbar plate 1561 and may be coupled with the second busbar frame 157 through the second coupling hole STA2.

Although not shown in FIG. 7, the first busbar frame 152, the first busbar 151, and the first terminal 1931 will also be coupled in a similar manner.

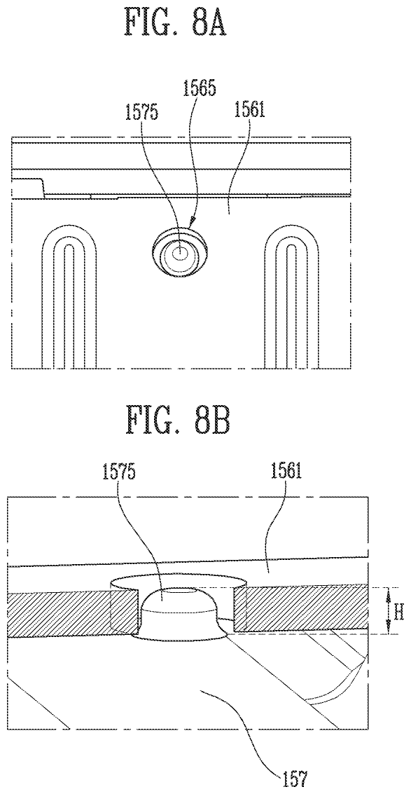

FIG. 8A shows an example of the second protrusion 1575 and the second insertion hole 1565. FIG. 8B shows a cross-section of the second protrusion 1575 and the second insertion hole 1565. When the second busbar plate 1561 is coupled with the second busbar frame 157, the second protrusion 1575 may be exposed to the outside of the cell stacking assembly 100 through the second insertion hole 1565.

Likewise, when the first busbar plate 1511 is coupled with the first busbar frame 152, the first protrusion 1525 may also be exposed to the outside of the cell stacking assembly 100 through the first insertion hole 1515.

The height (H) at which the second protrusion 1575 protrudes from the second busbar frame 157 may be equal to or less than the thickness of the second busbar plate 1561.

Likewise, the height at which the first protrusion 1525 protrudes from the first busbar frame 152 may be equal to or less than the thickness of the first busbar plate 1511. This is because when the first protrusion 1525 and the second protrusion 1575 protrude outwardly from the first busbar plate 1511 and the second busbar plate 1561, respectively, a module case 210 accommodating the cell stacking assembly must be unnecessarily large.

The present disclosure may be modified and implemented in various forms, and its scope is not limited to the embodiments described above. Therefore, if a modified embodiment includes components of the present disclosure, it should be regarded as falling within the scope of the rights of the present disclosure.

What is claimed is:

1. A cell stacking assembly comprising:
a plurality of battery cells stacked along a preset stacking direction and each including a first lead tab portion and a second lead tab portion;
a first busbar positioned in a direction in which the first lead tab portion protrudes to electrically connect each of the first lead tab portions;
a first busbar frame coupled with the first busbar to support the first busbar;
a second busbar positioned in a direction in which the second lead tab portion protrudes to electrically connect each of the second lead tab portions;
a second busbar frame coupled with the second busbar to support the second busbar;
a first protrusion protruding from the first busbar frame toward the first busbar;
a first insertion hole positioned on the first busbar and into which the first protrusion is inserted;
a second protrusion protruding from the second busbar frame toward the second busbar; and
a second insertion hole positioned on the second busbar and into which the second protrusion is inserted.

2. The cell stacking assembly according to claim 1, wherein the first busbar, the first busbar frame, the second busbar, and the second busbar frame extend along the stacking direction.

3. The cell stacking assembly according to claim 2, wherein the distance from the front surface of the first busbar frame to the first protrusion along the stacking direction is different from the distance from the front surface of the second busbar frame to the second protrusion along the stacking direction.

4. The cell stacking assembly according to claim 3, wherein the height from the bottom of the first busbar frame to the first protrusion is different from the height from the bottom of the second busbar frame to the second protrusion.

5. The cell stacking assembly according to claim 1, further comprising:
a first protruding portion protruding from the first busbar frame in a direction toward the first busbar;
a first through-hole formed through the first busbar corresponding to the position of the first protruding portion;
a second protruding portion protruding from the second busbar frame in a direction toward the first busbar; and
a second through-hole formed through the second busbar corresponding to the position of the second protruding portion.

6. The cell stacking assembly according to claim 5, wherein the protruding height of the first protruding portion based on the first busbar frame is greater than the protruding height of the first protrusion; and
the protruding height of the second protruding portion based on the second busbar frame is greater than the protruding height of the second protrusion.

7. The cell stacking assembly according to claim 5, wherein the first busbar and the first busbar frame are coupled with each other by thermal bonding of the first protruding portion; and
the second busbar and the second busbar frame are coupled with each other by thermal bonding of the second protruding portion.

8. The cell stacking assembly according to claim 7, wherein the maximum outer diameter of the first protruding portion is larger than the maximum outer diameter of the first protrusion; and
the maximum outer diameter of the second protruding portion is larger than the maximum outer diameter of the second protrusion.

9. The cell stacking assembly according to claim 1, wherein the first protrusion is provided in a plural number on the first busbar frame along a stacking direction in which the plurality of battery cells are stacked;
the first insertion hole includes a plurality of first insertion holes that are formed through the first busbar at a position corresponding to any one of the first protrusions;
the second protrusion is provided in a plural number on the second busbar frame along a stacking direction in which the plurality of battery cells are stacked; and
the second insertion hole includes a plurality of second insertion holes that are formed through the second busbar at a position corresponding to any one of the second protrusions.

10. The cell stacking assembly according to claim 9, wherein the plurality of first protrusions are disposed at a preset first interval; and
the plurality of second protrusions are disposed at a preset second interval.

11. The cell stacking assembly according to claim 9, wherein the first busbar includes a plurality of first busbar plates, and each of the plurality of first busbar plates includes any one insertion hole among the plurality of first insertion holes; and
the second busbar includes a plurality of second busbar plates, and each of the plurality of second busbar plates includes any one insertion hole among the plurality of second insertion holes.

12. The cell stacking assembly according to claim 11, wherein the distance from the front surface of the first busbar frame to each of the plurality of first insertion holes is different from the distance from the front surface of the second busbar frame to each of the plurality of second insertion holes.

13. The cell stacking assembly according to claim 1, wherein the first busbar includes a first terminal that is provided to detect the voltage of the plurality of battery cells; and
the second busbar includes a second terminal that is electrically connected to the first busbar.

14. The cell stacking assembly according to claim 13, wherein the distance from the front surface of the first busbar frame to the first terminal along the stacking direction, which is a direction in which the plurality of battery cells are stacked, is different from the distance from the front surface of the second busbar frame to the second terminal along the stacking direction.

15. A battery module comprising:
a cell stacking assembly according to claim 1; and
a module case accommodating the cell stacking assembly therein.
